(19) United States
(12) Patent Application Publication
(10) Pub. No.: US 2023/0060707 A1
(43) Pub. Date: Mar. 2, 2023

(54) SYSTEMS AND METHODS FOR INCLUDING A DATA ACCEPTANCE CONDITION IN A DATA TRANSFER PROPOSAL

(71) Applicant: The Toronto-Dominion Bank, Toronto (CA)

(72) Inventors: Milos DUNJIC, Oakville (CA); David Samuel TAX, Toronto (CA); Kushank RASTOGI, Toronto (CA)

(73) Assignee: The Toronto-Dominion Bank, Toronto (CA)

(21) Appl. No.: 17/465,254

(22) Filed: Sep. 2, 2021

(51) Int. Cl. G06Q 20/40; G06Q 20/06

(52) U.S. Cl. CPC G06Q 20/405; G06Q 20/06; G06Q 20/403; G06Q 20/4014

(57) ABSTRACT

Methods and computer systems for including a data acceptance condition in a data transfer proposal. Receiving, from a second computing system, a transfer message for a transfer between a first account associated with a first computing system and a second account associated with the second computing system, the transfer message including routing data, an amount of resources to be transferred, and a condition associated with the transfer. Evaluating the condition associated with the data transfer based on a comparison between data included in the transfer message and one or more parameters associated with the first account. When the condition is determined to be satisfied, completing the transfer.

### FIELD

The present disclosure relates to electronic data transfer systems and, more particularly, to systems and methods for including a data acceptance condition in a data transfer proposal.

### BACKGROUND

Data is often electronically transferred between computer systems. Unfortunately, some users may unintentionally make errors when entering data into computer systems, while others may use such computer systems to deliberately cause fraud. As a result, data may not be transferred as desired.

It would be advantageous to provide for enhanced security for data transfers and increased usability of these systems.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2 shows a high-level schematic diagram of the remote device of FIG. 1;

FIG. 3 shows a simplified organization of software components stored in a memory of the remote device of FIG. 2;

FIG. 4 shows a high-level schematic diagram of an example embodiment of the transferor and recipient computing systems of FIG. 1;

FIG. 5 shows a simplified organization of software components stored in the example computing systems of FIG. 4;

FIG. 6 shows, in block diagram form, an example embodiment of a data store of FIG. 1;

FIG. 7 is a flowchart showing operations performed in processing a data transfer proposal including a data transfer condition;

FIG. 8 is a simplified example of a payment user interface including a data acceptance condition;

FIG. 9 is simplified example of another payment user interface including a data acceptance condition; and

FIG. 10 is a simplified example of a request for payment user interface including a data acceptance condition.

### DETAILED DESCRIPTION OF EXAMPLE EMBODIMENTS

Similar reference numerals may have been used in different figures to denote similar components.

In one embodiment, the present application describes a first computer system. The first computer system may include a communications module; a processor coupled to the communications module; and a memory coupled to the processor. The memory may store instructions that, when executed by the first computer system, cause the first computer system to: receive, from a second computing system, a transfer message for a transfer between the first account associated with the first computing system and a second account associated with the second computing system, the transfer message including routing data, an amount of resources to be transferred, and a condition associated with the transfer; evaluate the condition associated with the data transfer based on a comparison between data included in the transfer message and one or more parameters associated with the first account; and when the condition is determined to be satisfied, complete the transfer.

In this way, by providing a data acceptance condition in a data transfer proposal, a transferor or recipient system may provide increased security for processing data transfers.

In some implementations, the comparison between data included in the transfer message and one or more parameters associated with the first account may include a comparison between a value specified by the condition and one or more parameters associated with the first account.

In some implementations, the condition may include a value to be used in the comparison.

In some implementations, the one or more parameters associated with the first account may include an age of the first account or a type of the first account.

In some implementations, the one or more parameters associated with the first account may include contact information of an account holder.

In some implementations, the one or more parameters associated with the first account may include an age of an account holder.

In some implementations, the transfer message may be provided as a request for payment.

In some implementations, the instructions may further cause the first computer system to, when the condition is determined to not be satisfied, stop the transfer from being completed.

In some implementations, the instructions may further cause the first computer system to send, in real time or near real time upon receipt of the transfer message, a reply to the second computing system indicating the result of the evaluation.

In some implementations, receiving the transfer message indicating the condition associated with the transfer may include receiving user input from a client device via the second system indicating the condition associated with the transfer.

In another aspect, present application describes a method. The method may include receiving, from a second computing system, a transfer message for a transfer between the first account associated with the first computing system and a second account associated with the second computing system, the transfer message including routing data, an amount of resources to be transferred, and a condition associated with the transfer; evaluating the condition associated with the data transfer based on a comparison between data included in the transfer message and one or more parameters associated with the first account; and when the condition is determined to be satisfied, completing the transfer.

In some embodiments, the method may further include, when the condition is determined to not be satisfied, stopping the transfer from being completed.

In some embodiments, the method may further include sending, in real time or near real time upon receipt of the transfer message, a reply to the second computing system indicating the result of the evaluation.

In yet another aspect, present application describes a non-transitory computer-readable storage medium comprising processor-executable instructions which, when executed, configure a processor to: receive, from a second computing system, a transfer message for a transfer between the first account associated with the first computing system and a second account associated with the second computing system, the transfer message including routing data, an amount of resources to be transferred, and a condition associated with the transfer; evaluate the condition associated with the data transfer based on a comparison between data included in the transfer message and one or more parameters associated with the first account; and when the condition is determined to be satisfied, complete the transfer.

In yet another aspect, the present application discloses a non-transitory, computer-readable medium storing processor-executable instructions that, when executed by one or more processors, are to cause the one or more processors to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of ...or...” is intended to cover any one or more of the listed elements, including any one of the listed elements alone, any subcombination, or all of the elements, without necessarily excluding any additional elements, and without necessarily requiring all of the elements.

The present application makes reference to a “transfer message”, which is a computer-readable message configured for transmission over one or more computer networks between a sending device and a receiving device. The transfer message may be a structured message having a defined schema or set of predefined fields to contain data. The transfer message may be used to transfer resources from one entity to another entity. In particular, the transfer message may be used to effect a change in recorded ownership of resources. The resources may be currency, physical assets, credits, tokenized items like non-fungible tokens, computing resources such as memory allocated or processor time, access rights, or any other resource that may be owned or credited to an account associated with an account holder. In many of the examples below, monetary resources may be referenced to illustrate concepts, but the present application is not necessarily solely applicable to financial or monetary instruments or resources.

A transfer message may be or include a request to transfer. A request to transfer may be a specially formatted message that is sent from a first database management system to a second database management system. The request to transfer may be sent from the first database management system to the second database management system over a transfer rail that is used for facilitating transfers between databases associated with different database management systems. For example, the first database management system may be associated with a first database and the second database management system may be associated with a second database. The databases may store account data. That is, the databases may store data that is associated with various accounts. In at least some implementations, each record in the database may be associated with a particular one of these accounts.

A request to transfer is a message that is sent on behalf of a recipient to initiate a transfer from a sender to the recipient. That is, the request to transfer is sent, on behalf of the recipient, from the database management system associated with the recipient to the database management system associated with the sender. The request to transfer requests a transfer from a record in the database that is associated with the sender to a record in the database that is associated with the recipient. The request to transfer includes one or more identifiers that identify the record associated with the sender and/or the record associated with the recipient. The identifier(s) may be or include an account number. The request to transfer may also include one or more identifiers that identify the database management system associated with the sender and/or that identify the database management system associated with the recipient. Such identifiers may be or include one or more of: a transit number and an institution number.

The request to transfer is a transfer initiation message. That is, the request to transfer is an initial message that may be used to cause a transfer to occur. Since the request to transfer is initiated by a recipient rather than a sender, the request to transfer may be considered to a pull-style transfer, which may be contrasted with typical push-style transfers. In at least some implementations, the request to transfer may be formatted as an ISO20022 message.

The request to transfer message is specially formatted to include parameters of a transfer that is requested to be made from a sender. The parameters may be included as metadata in the transfer message. Where the request to transfer is an ISO20022 message, the parameters may be included in an ISO20022 format. The parameters may include resource definition data. The resource definition data defines what is requested to be transferred. By way of example, the resource definition data may define a resource that is stored in or otherwise associated with a record associated with the sender. The resource may be, for example, a computing resource. In another implementation, the resource may be data. In some implementations, the resource may represent an amount of value, such as a quantity of a currency.

The parameters that are included in the request to transfer may include data of another type. For example, in some implementations, the parameters may be or include transfer scheduling data. The transfer scheduling data may represent a time when the requested transfer is to be made. This time may be, for example, a due date or deadline. The due date or deadline represents a latest time at which the transfer is to be made.

The request to transfer message may, in some implementations, be or represent a request for payment. Such a message may be referred to as a request for payment (RFP) message or a request to pay (RTP) message. In such implementations, the transfer rail may be a payment rail such as a real time payment rail and the database management systems may be a financial institution systems. In at least some such implementations, the records may represent bank accounts and a transfer may be a request to transfer value from a sender bank account to the recipient bank account. The request to transfer message may be sent from a first financial institution system, which is associated with a first financial institution, to a second financial institution system, which is associated with a second financial institution.

The request to transfer message is a special transfer message which is not formatted as an email or short message service (SMS) message. Rather, it is a computer-to-computer message that is formatted to be specially processed by the database management system that receives it. In at least some implementations, the computer-to-computer message may be formatted according to the ISO20022 standard. For example, the database management system that receives the request to transfer message may be configured to execute a process for obtaining authorization to complete a transfer in response to receiving the request to transfer. More particularly, the database management systems may be configured to only permit authorized transfers. For example, in one implementation, the database stores account data for a plurality of accounts and a database management system will only allow a transfer out of an account if the transfer is authorized by an authorization entity for that account, such as an account holder. Authorization may, for example, require authenticated approval using a credential such as one or more of a username, password, biometric authentication data or other credential.

In one implementation, in response to receiving the transfer message, a database management system may identify an affected account using an identifier defined by the transfer message. Then, the database management system may send an electronic notification to a client device associated with the identified account. This notification may be provided as an in-application notification or operating system level notification. The notification may include a selectable option to authorize the transfer.

The notification may allow the transfer to be made without requiring input of one or more parameters that are typically required when a transfer is initiated by the sender rather than the recipient. By way of example, one or more parameters that are included in the request to transfer may be used to pre-stage or pre-populate parameters of the transfer so that the sender does not have to input such parameters. In some implementations, the resource definition data included in the request to transfer may be used to allow the transfer to be made without having the sender define what is to be transferred. For example, where the transfer is a transfer of a computing resource or data, the sender may perform the transfer without having to input any information defining the computing resource or data involved. Or, where the transfer is a transfer of an amount of value, the amount of value defined in the request for transfer message may be used so that the sender does not have to define the amount of value.

In some implementations, transfer scheduling data included in the request to transfer message may be used to schedule the transfer without requiring the sender to define such a schedule. For example, where the transfer scheduling data is a due date or deadline, the database management system associated with the sender may automatically define a time for a transfer based on the transfer scheduling data without requiring the sender to input such a time.

In this way, the sender may cause a database management system that is associated with the sender’s record in a database to perform the transfer without having to input any parameters for the transfer.

The present application further makes reference to a “data transfer proposal”, which may refer to a transfer message that includes a condition that must be satisfied before a data transfer indicated by the transfer message may occur.

In the present application, the terms “transferor” and “transferee” may be used interchangeably with “sender” and “recipient”, respectively, in the context of describing transfers of resources. In some cases, the terms “payor” or “payee” may be used in the example of monetary resources.

Many of the embodiments described herein focus on a transfer message that is provided as either a payment or request for payment. However, it is understood that the present application is not limited to any such embodiments and that the embodiments described with respect to a particular type of transfer generally may be extended to other types of transfers.

In the present application, the term “real-time” may be used interchangeably with “near real-time” or “substantially in real-time”. In at least some embodiments, real-time is defined as being within seconds. Certain factors, such as network traffic, may limit the immediacy of real-time transfers and/or processing of transfer messages.

Example embodiments of the present application are not limited to any particular operating system, system architecture, mobile device architecture, server architecture, or computer programming language.

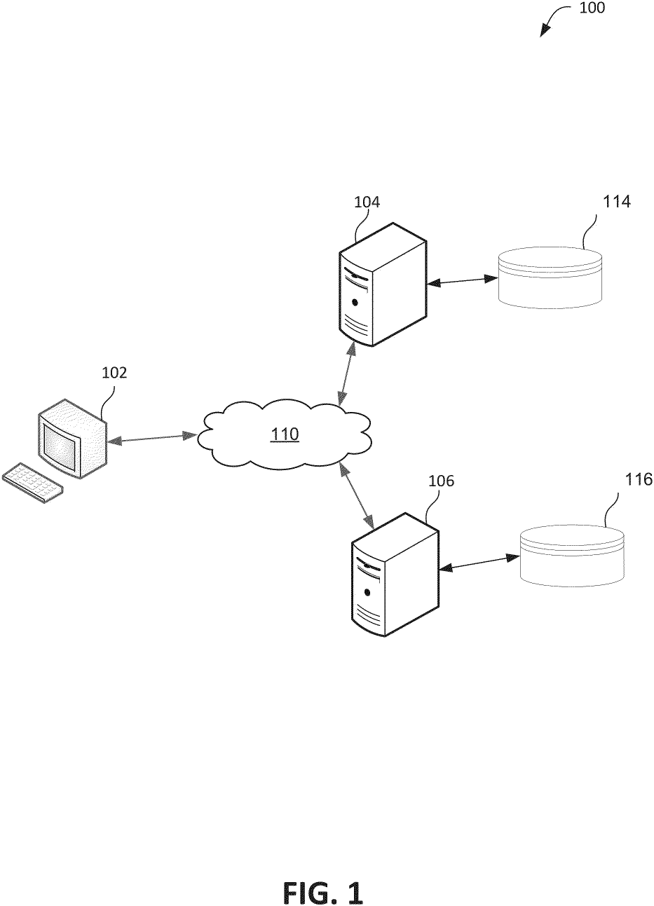

FIG. 1 shows a schematic diagram illustrating an operating environment of an example embodiment. The operating environment in this example includes a remote device 102, a first system 104 and a second system 106.

As illustrated, the first system 104 may provide a front-end interface which allows the remote device 102 to interact with the first system 104. For example, the first system 104 may provide one or more graphical user interfaces (GUIs) to the remote device 102. By way of example, the first system 104 may provide, to the remote device 102, a user interface. The user interface provided to the remote device 102 may be an interface for configuring a data transfer proposal.

The first system 104 may be managed, operated, or controlled by an entity that is responsible for preparing the data transfer proposal and for receiving user input from the remote device 102 indicating details of data transfer proposal. The entity may be an agent of a first account holder and may be a financial institution, such as a bank. The first account holder may be a customer (e.g. a corporate/business customer) or client of the entity or otherwise associated with the entity.

The first system 104 may store data regarding one or more data transfer proposals in a plurality of respective data transfer proposal objects. The first system 104 may further store data regarding users or customers associated with the first system 104 in a plurality of respective user account objects representing respective user accounts.

The first system 104 may be used to transmit a message to a system associated with a second account holder, for example, the second system 106.

As illustrated, the first system 104 is in communication with the second system 106 via the network 110. The first system 104 may be configured to transmit to the second system 106 a message and a data transfer proposal. The second system 106 may be further configured to receive a message and a data transfer proposal from the first system 104.

The second system 106 may be managed, operated, or controlled by an entity that is responsible for receiving the data transfer proposal. The entity may be an agent of a second account holder and may be a financial institution, such as a bank. The second account holder may be a customer (e.g. a corporate/business customer) or client of the entity or otherwise associated with the entity.

The second system 106 may store data regarding one or more data transfer proposals in a plurality of respective data transfer proposal objects. The second system 106 may further store data regarding users or customers associated with the second system 106 in a plurality of respective user account objects representing respective user accounts.

The first system 104 and the second system 106 may be configured to ingest data from each other and may transmit alerts, notifications, configuration objects, or other data to each other and/or the remote device 102. More particularly, the first system 104 may include infrastructure configured to receive a message from the second system 106 and transmit a notification to the remote device 102 and/or the second system 106 in response to receiving the message.

The first system 104 and the second system 106 may store data in respective data stores 114 and 116. The data stores 114 and 116 are illustrated as single units for ease of illustration, but may include a plurality of storage units and, in some cases, storage media connected via the network 110.

As illustrated, the remote device 102 is in communication with a first system 104 via a network 110. The remote device 102 may be managed, operated or controlled by the first account holder. The remote device 102 may be associated with an alias associated with the first account holder and a user account associated with the first account holder and the first system 104. The remote device 102 may be engaged using the alias.

The remote device 102 may be used, for example, to receive user input that includes an indication of a data acceptance condition in a data transfer proposal. The user input may further include an indication of routing data, intended transferor, recipient, an account associated with the intended transferor, an account associated with the recipient, and other information to be included in or used to construct the data transfer proposal.

The remote device 102 is a computing device. It may, as illustrated, be a desktop computer. However, the remote device 102 may be a computing device of another type such as, for example, a smart phone, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The first system 104 and second system 106 are or include a computer system such as a computer server system or a database management system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The remote device 102, first system 104 and second system 106 may be in geographically disparate locations.

The network 110 is a computer network. The network 110 may be an internetwork such as may be formed of one or more interconnected computer networks. For example, such a network may be or may include an Ethernet network, an asynchronous transfer mode (ATM) network, a wireless network, or the like. In some implementations, the network 110 may be the Internet. The network 110 allows the remote device 102, first system 104 and second system 106 to communicate with one another.

As further described below, the remote device 102, the first system 104 and second system 106 may be configured with software to perform associated functions such as those described herein.

FIG. 1 illustrates the first system 104, second system 106, and data stores 114 and 116 as separate computing devices. However, these systems may not be separate physical systems. For example, the first system 104 and the data store 114 may be implemented on a common physical device. As another example, the second system 106 and the data store 116 may be implemented on a common physical device. As yet another example, the first system 104 and second system 106 may be implemented in software associated with a common processor. As yet a further example, the data stores 114 and 116 may be included in the first system 104 and second system 106, respectively, or may be external to those systems.

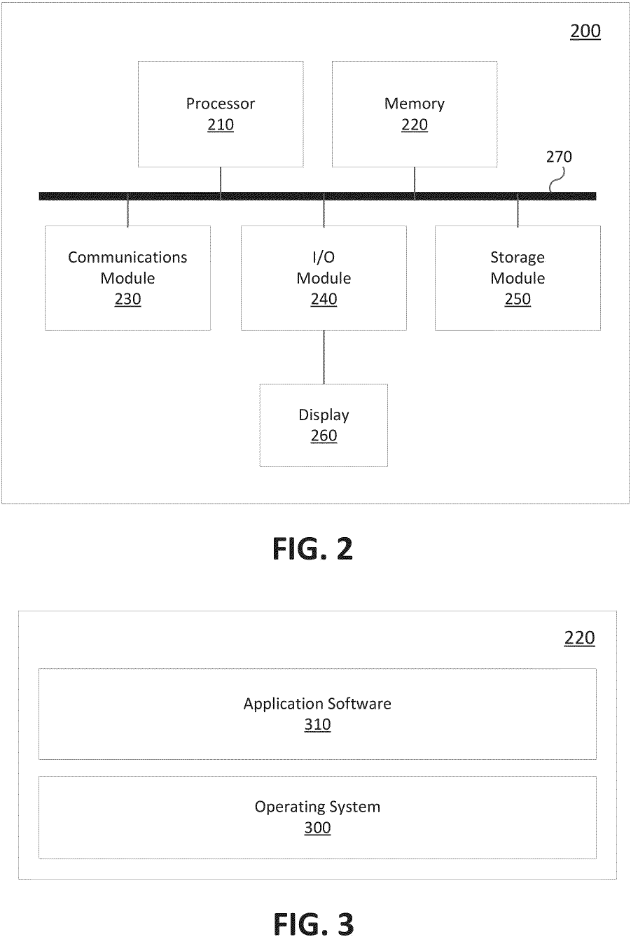

An example embodiment of the remote device 102 will now be discussed with reference to FIG. 2. FIG. 2 is a high-level schematic diagram of the remote device 100. The remote device 102 may, in some embodiments, be a personal computer as shown in FIG. 1.

The remote device 102 includes a variety of modules. For example, as illustrated, the example computing device 200 may include a processor 210, a memory 220, a communications module 230, an I/O module 240, and/or a storage module 250. As illustrated, the foregoing example modules of the example computing device 200 are in communication over a bus 270. As such, the bus 270 may be considered to couple the various modules of the remote device 102 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the remote device 102.

The communications module 230 allows the remote device 102 to communicate with other computing devices and/or various communications networks such as, for example, the network 110. For example, the communications module 230 may allow the remote device 102 to send or receive communications signals. Communications signals may be sent or received according to one or more protocols or according to one or more standards. The communications module 230 may allow the remote device 102 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 230 may allow the remote device 102 to communicate using near-field communication (NFC), via Wi-Fi (TM), using Bluetooth (TM) or via some combination of one or more networks or protocols. In some embodiments, all or a portion of the communications module 230 may be integrated into a component of the remote device 102. For example, the communications module 230 may be integrated into a communications chipset.

The I/O module 240 is an input/output module. The I/O module 240 allows the remote device 102 to receive input from and/or to provide input to components of the remote device 102 such as, for example, various input modules and output modules. For example, the I/O module 240 may, as shown, allow the remote device 102 to receive input from and/or provide output to the display 260.

The storage module 250 allows data to be stored and retrieved. In some embodiments, the storage module 250 may be formed as a part of the memory 220 and/or may be used to access all or a portion of the memory 220. Additionally or alternatively, the storage module 250 may be used to store and retrieve data from persisted storage other than the persisted storage (if any) accessible via the memory 220. In some embodiments, the storage module 250 may be used to store and retrieve data in/from a database. A database may be stored in persisted storage. Additionally or alternatively, the storage module 250 may access data stored remotely such as, for example, as may be accessed using a local area network (LAN), wide area network (WAN), personal area network (PAN), and/or a storage area network (SAN). In some embodiments, the storage module 250 may access data stored remotely using the communications module 230. In some embodiments, the storage module 250 may be omitted and its function may be performed by the memory 220 and/or by the processor 210 in concert with the communications module 230 such as, for example, if data is stored remotely.

The remote device 102 may include or be connected to a display 260. The display 260 is a module of the remote device 102. The display 260 is for presenting graphics. The display 260 may be, for example, a liquid crystal display (LCD). In addition to being an output device, the display 260 may also be an input device. For example, the display 260 may allow touch input to be provided to the remote device 102. In other words, the display 260 may be a touch sensitive display module. In a particular example, the display 260 may be a capacitive touch screen.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the remote device 102. As illustrated, these software components include an operating system 300 and an application software 310.

The operating system 300 is software. The operating system 300 allows the application software 310 to access the processor 210 (FIG. 3), the memory 220, the communications module 230, the I/O module 240, and the storage module 250 of the remote device 100. The operating system 300 may be, for example, Google (TM) Android (TM), Apple (TM) iOS (TM), UNIX (TM), Linux (TM), Microsoft (TM) Windows (TM), Apple OSX (TM) or the like.

The application software 310 adapts the remote device 102, in combination with the operating system 300, to operate as a device for facilitating data transfers and data transfer proposals.

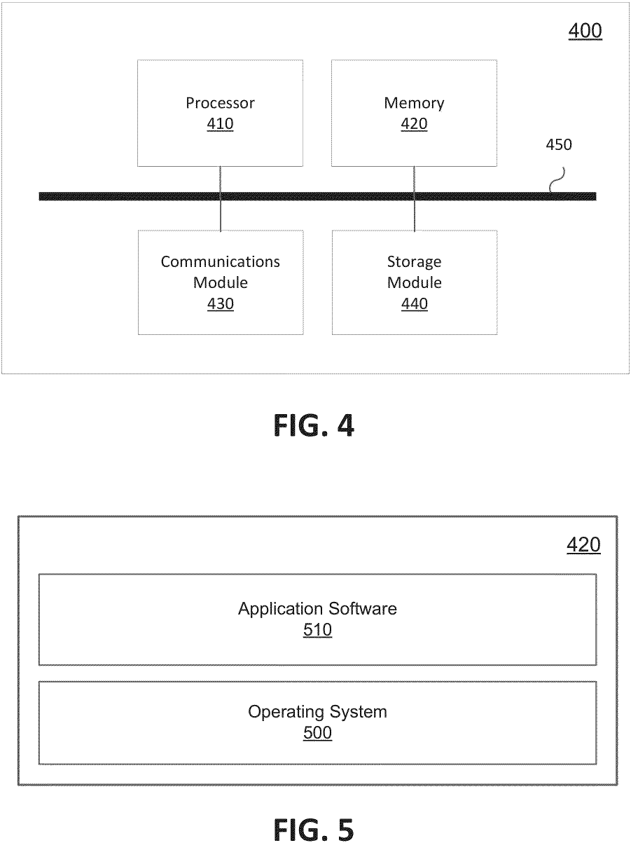

As noted above, the first system 104 and second system 106 are or include a computer system. An example computer system 400 will now be discussed with reference to FIGS. 4 and 5. Suitably-configured instances of the example computer system 400 may, in some embodiments, serve as and/or be a part of the first system 104 and/or second system 106.

FIG. 4 is a high-level schematic diagram of an example computer system 400.

The example computer system 400 includes a variety of modules. For example, as illustrated, the example computer system 400 may include a processor 410, a memory 420, a communications module 430, and/or a storage module 440. As illustrated, the foregoing example modules of the example computer system 400 are in communication over a bus 450. As such, the bus 450 may be considered to couple the various modules of the example computer system 400 to each other, including, for example, to the processor 410.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer system 400.

The communications module 430 allows the example computer system 400 to communicate with other computing devices and/or various communications networks such as, for example, the network 110. The communications module 430 may allow the example computer system 400 to send or receive communications signals. Communications signals may be sent or received according to one or more protocols or according to one or more standards. For example, the communications module 430 may allow the example computer system 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 430 may allow the example computer system 400 to communicate via Wi-Fi (TM), using Bluetooth (TM) or via some combination of one or more networks or protocols. In some embodiments, all or a portion of the communications module 430 may be integrated into a component of the example computer system 400. For example, the communications module may be integrated into a communications chipset.

The storage module 440 allows the example computer system 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persisted storage other than the persisted storage (if any) accessible via the memory 420. In some embodiments, the storage module 440 may be used to store and retrieve data in a database. A database may be stored in persisted storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access data stored remotely using the communications module 430. In some embodiments, the storage module 440 may be omitted and its function may be performed by the memory 420 and/or by the processor 410 in concert with the communications module 430 such as, for example, if data is stored remotely.

Software comprising instructions is executed by the processor 410 from a computer-readable medium. For example, software may be loaded into random-access memory from persistent storage of the memory 420. Additionally or alternatively, instructions may be executed by the processor 410 directly from read-only memory of the memory 420.

FIG. 5 depicts a simplified organization of software components stored in the memory 420 of the example computer system 400. As illustrated, these software components include an operating system 500 and an application software 510.

The operating system 500 is software. The operating system 500 allows the application software 510 to access the processor 410, the memory 420, the communications module 430, and the storage module 440 of the example computer system 400. The operating system 500 may be, for example, UNIX (TM), Linux (TM), Microsoft (TM) Windows (TM), Apple OSX (TM) or the like.

The application software 510, when executed, co-operates with the operating system 500 to adapt the example computer system 400 for some purpose and to provide some defined functionality. For example, the application software 510 may cooperate with the operating system 500 to adapt a suitable embodiment of the example computer system 400 to serve as the first system 104 and/or second system 106.

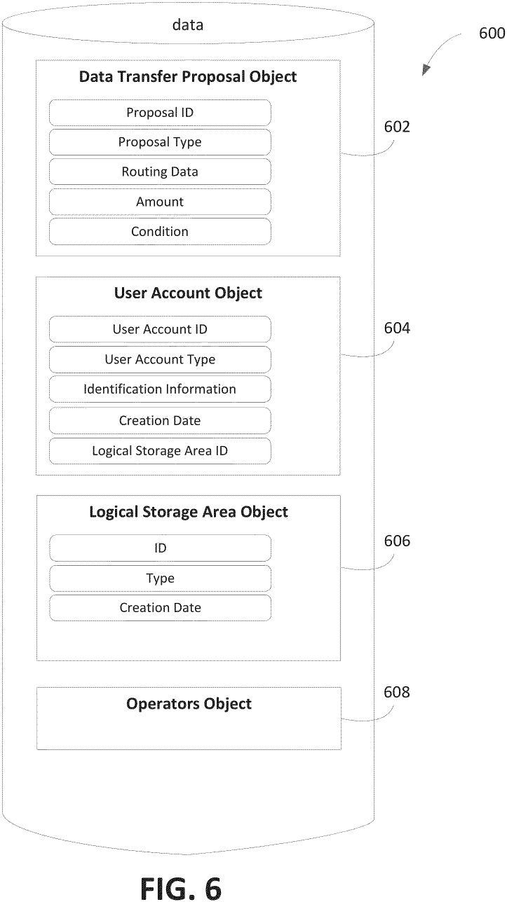

Reference is now made to FIG. 6, which partially illustrates an example data store 600 in block diagram form. The data store may be a data store 114 of the example first system 104 of FIG. 1 and/or a data store 116 of the example second system 106 of FIG. 1. Not all components of the data store 600 are illustrated. The data store 600 may include one or more data storage units. In some cases, the stored data may be in a database format and may include one or more databases. The databases may be relational databases in some examples.

The data store 600 may store data regarding a data transfer proposal in a data transfer proposal object 602. The data transfer proposal object 602 may be a data structure and may contain details or parameters regarding a data transfer proposal.

Example parameters that may be included in a data transfer proposal include:
a proposal identifier identifying the particular data transfer proposal;
identification information of the type of data transfer proposal (e.g. payment, or request for payment);
identification information of the first and/or second account holders (e.g. full name, postal address, contact details, telephone number, email address, alias);
an amount of resources to be transferred;
routing data, which may include:
   identification information of the first and/or second system and/or the entity associated with, operating or managing the first and/or second system (e.g. a routing number, financial institution identifier, and/or branch transit number associated with the first and/or second system); and/or
   identification information of a first and/or second logical storage area, for example, a logical storage area identifier (e.g. bank account number), associated with, managed or controlled by a respective first and/or second account holder to or from which the amount of resources is to be transferred; and
a condition for the transfer including, for example, a variable or data type for an account holder, a comparator, and a value that is to be used in the comparison.

The data store 600 may further store data regarding an account holder in a user account object 604. A user account object 604 may be a data structure and may include details regarding an individual or entity holding an account or other logical storage area. Example details include a user account identifier indicating a particular person or entity, identification information (e.g. first and last name), an alias (e.g. email address, phone number), contact information (e.g. home address), date of birth, date of incorporation, and sign in or authentication credentials (e.g. user name, password, access card number). The account holder may be or represent a transferor, recipient, payor, payee, customer or user.

A user account object 604 may be associated with a logical storage area. A logical storage area may be or include an area of the data store 600. A logical storage area may further be or represent a bank account or other logical storage area for storing a quantity of a resource. In some embodiments, the data store 600 may include a database of customer accounts and bank accounts at a particular financial institution.

A user account object 604 may include one or more identifiers that may link to one or more respective logical storage areas. For example, a user account object 604 may include a logical storage area identifier indicating a logical storage area that is associated with an account holder.

The data store 600 may further store data regarding possible comparison operators in an operators object 608. The operators object 608 may include a plurality of defined operators that may be used by the first system 104 to provide a customized data transfer experience. The plurality of defined operators may include at least one of the following operators: “equal to”, “not equal to”, “greater than”, “less than”, “greater than or equal to”, “less than or equal to”, and “contains”.

The data store 600 may further store a directory of aliases that may be used to map an alias to routing data for a data transfer proposal. For instance, an alias may be an email address associated with the second account holder that maps to an identifier of a financial institution at which the second account holder is a customer and default account associated with that financial institution. In other words, the alias can be used to lookup the second account holder’s financial institution in the directory and a default logical storage area identifier associated with the second account.

The first system 104 and second system 106 illustrated in FIG. 1 may store one or more data transfer proposal objects 602, user account objects 604, logical storage area objects 606, and operators objects 608 in a data stores 114 and/or 116.

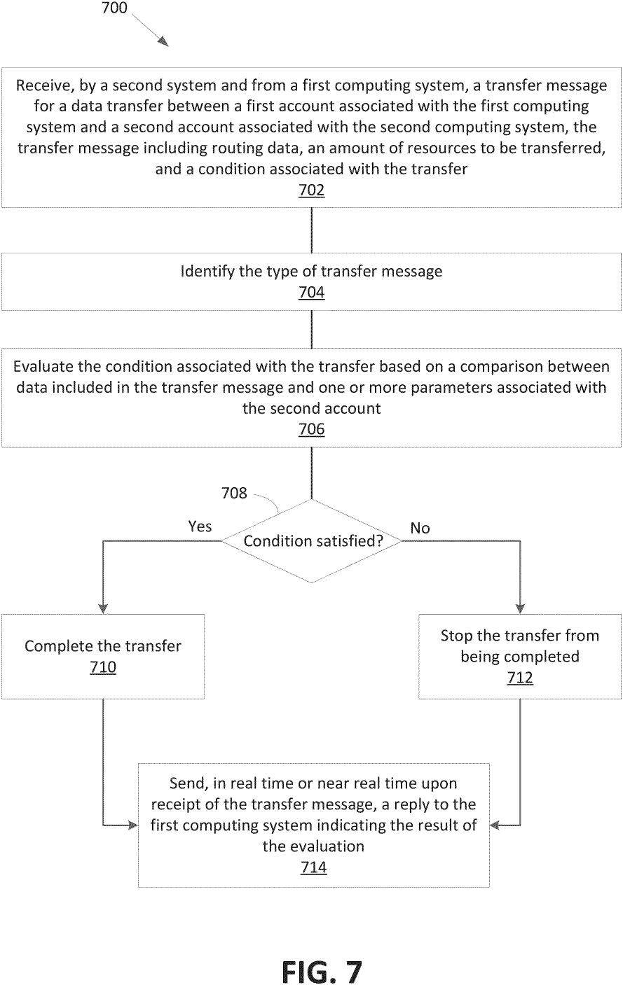

Reference will now be made to FIG. 7 which illustrates an example method 700. The operations of method 700 may be performed by a second system 106 which may be of the type described herein.

In operation 702, a first system may receive, via a communications module and from a second system, a transfer message for a data transfer between a first account associated with the first system and a second account associated with a second system. The transfer message may be provided as a payment or a request for payment and may include routing data, an amount of resources to be transferred, and a condition associated with the transfer. In some instances, the transfer message may include multiple conditions.

In some embodiments, the transfer message may also be populated with a flag that flags the transfer message as one that includes a condition. This may be done, for example, by including a predetermined code or string in a predetermined field or, if the payment message includes a field that is specifically used for adding a flag categorizing the message as one that includes a condition, by setting the flag in such a field. In some instances, a second system may auto-decline certain transfer messages if they do not include a transfer condition.

In operation 704, upon receiving the transfer message, the second system may identify a category or type of the transfer message. The category or type may be, for example, one or more of the following: payment; or request for payment. When the transfer message is received, the contents of the transfer message may be analyzed to determine the category or type associated with the transfer message. For example, the transfer message may include a category identifier or type identifier representing a category or type of the transfer message. The category or type identifier may specify a “payment” or a “request for payment” category or type. The identifier may be a category specified in a standard set of possible category identifiers.

In operation 706, upon receiving the transfer message and analyzing the contents of the transfer message in order to determine the condition associated with the data transfer, the second system may evaluate the condition associated with the transfer based on a comparison between data included in the transfer message and one or more parameters associated with the second account. The one or more parameters associated with the second account may include data stored in a user account object. In other words, the condition may be evaluated based on account data for an account referenced by the transfer message. In some embodiments, the evaluation involves a comparison between data included in the transfer message and data not included in the transfer message. The comparison data that is not included in the transfer message may be account data associated with the second system.

In some embodiments, the transfer message may be provided as a payment message and the condition may be a deposit condition. The deposit condition may be a condition related to the age, or other biographic data associated with the intended recipient of the payment. For example, in some implementations, the deposit condition may require that the account holder of the account into which a payment is being made is over the age of majority. Such a deposit condition may be useful when a regulated gaming operator is making a payment for a win that occurred at a casino, racetrack, or lottery. The operator of such an establishment may be required to ensure that the recipient is sufficiently old to comply with regulations and the age may be evaluated using a deposit condition inserted into a payment message.

Various other conditions may be specified instead of or in addition to an age-based condition. For example, a condition may be based on a location of the recipient. More particularly, the condition may require the recipient to have an address is a certain city, state, or country. By way of further example, a condition may be based on the age of the recipient’s account. For example, the payment message may require that the recipient’s account be at least 1 month, 2 months, 1 year old, etc. This may, for example, help to guard against fraud that is conducted through the opening of new account that receives funds that are quickly withdrawn.

By way of further example, a deposit condition may be based on a recipient’s birthday. For example, the deposit may be a promotion that is payable on an individual’s birthday and it may require that the current day be the recipient’s birthday.

By way of further example, the deposit condition may be based on a balance associated with an account. For example, the condition may specify that the deposit will only occur if the recipient has a balance that is less than a threshold. By way of example, a parent may send such a transfer to a child.

By way of further example, a deposit condition may require that a name associated with an account matches a specified name. Such a condition may be used to guard against fraud, for example.

By way of further example, a deposit condition may require that an account be a personal account and not a business account, or vice versa.

The deposit condition may specify a variable or data type for a recipient that is to be compared (e.g. age, name, birthday, account age, etc.), a comparator (e.g., equals, greater than or equal to, etc.), and a value that is to be used in the comparison (e.g., 67, “John Smith”, etc.). The variable or data type may correspond to a parameter value associated with an account associated with the recipient. In this case, the second system use the parameter value in the comparison.

In operation 708, if the condition is satisfied, the second system may in operation 710 complete the transfer. Otherwise, the second system may in operation 712 stop the transfer from being completed.

In operation 714, the second system may send, in send, in real time or near real time upon receipt of the transfer message, a reply to the first computing system indicating the result of the evaluation. For example, if the condition is not satisfied, the second system may return an error message to the first system. The reply may further include an indication of the transfer message, and the one or more of the parameters associated with the second account.

The first system may present the reply to a user of a remote device via a user interface. The user interface may be that of a messaging application, such as an email application, text and/or voice message application, instant message application, or an application relating to a transferor identifier or recipient identifier included in the transfer message. In some embodiments, the user interface may be a graphical user interface that presents the notification via pop-up, alert, or in any other suitable manner.

Examples of user interfaces for generating and sending transfer messages will now be described. The user interfaces may include one or more features. A feature may be pre-populated with data or parameters. A feature may also solicit input and facilitate one or more selections from one or more options. In some cases, a feature may require active selection of an option, field, or setting. A feature may be implemented using one or more user interface elements, including menus, buttons, icons, radio buttons or option buttons, checkboxes, or other selectable graphical elements for initiating various operations in connection with the data transfer. A feature may include text boxes or other graphical elements for receiving input of text information, including numbers, for example, an amount of money, for use in various operations in connection with the data transfer. A feature may also include text, labels, images or other graphical elements for displaying information in the user interface.

In at least some embodiments, a user interface element may be invoked, actuated or otherwise selected by a user. Selection of a user interface element can include conventional user input operation on the user interface element so as to provide a signal or instruction to a browser application or other executing application that a selection of the user interface element has been made by the user and/or that a particular action represented by the user interface element is to be carried out. Different forms of selection, for example, by a touch, gesture, pointing device, or voice command, will be known to those skilled in the art. In some cases, a command, action, or operation associated with the user interface element can be invoked as a result of user input selecting or otherwise acting on a user interface element.

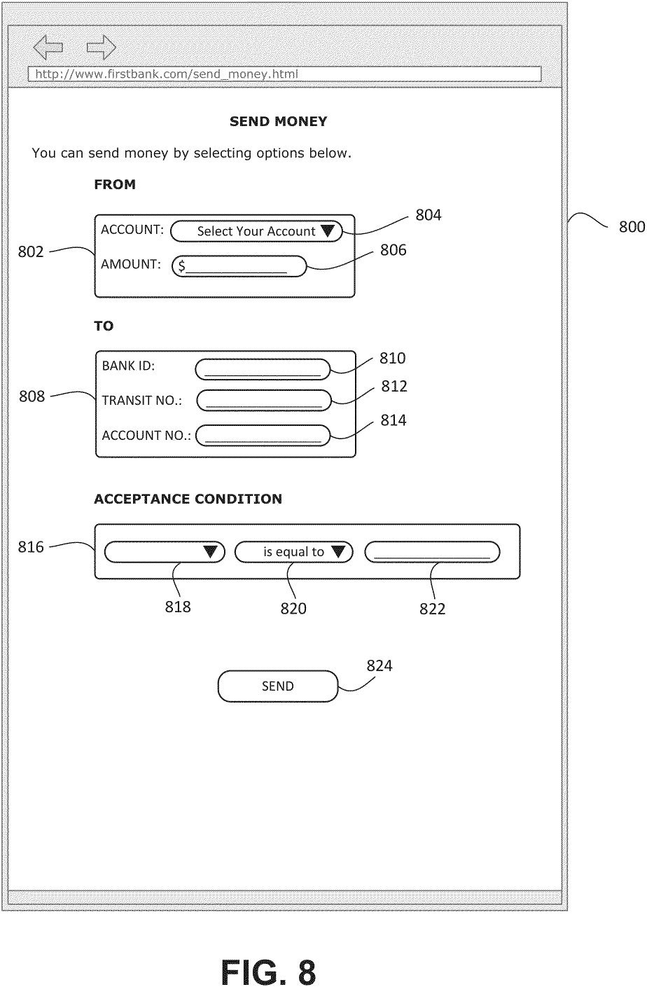

Reference will now be made to FIG. 8 which illustrates an example of a money transfer or payment interface 800. The money transfer interface 800 may be provided by a transferor system to a remote device. The transferor system may correspond to a first system 104 of FIG. 1.

The money transfer interface 800 prompts the user to provide details for a data transfer and displays user selectable options for the data transfer.

The example money transfer interface interface 800 includes a transferor feature 802 for receiving user input indicating details of the transferor. The transferor feature 802 includes a logical storage area or account element 804 for receiving user input indicating a logical storage area identifier associated with the transferor, in this example a bank account associated with the user, from which the indicated amount is to be transferred from. In other words, the account element 804 may prompt a user to select a logical storage area from which to make the data transfer. As illustrated, the account element 804 may include a drop-down list that displays the available logical storage areas from which the selected amount may be transferred. The available logical storage areas may include logical storage areas associated with the authenticated user. In some embodiments, the transferor system may use a default logical storage area identifier to preselect the default logical storage area in the account element 804.

The transferor feature 802 further includes an amount element 806 that provides an input area to receive data indicating the amount to be transferred.

The example money transfer interface interface 800 includes a routing data feature 808 for receiving user input indicating routing data associated with the intended recipient of the payment. The routing data feature 808 includes a bank identifier element 810, transit number element 812 and account number element 814 that provide input areas to receive data indicating a bank identifier, transit number and account number, respectively.

The example money transfer interface 800 includes a deposit or acceptance condition feature 816. As illustrated, the acceptance condition feature 816 includes a first operand element 818, a comparison operator element 820, and a second operand element 822. The deposit or acceptance condition may define a condition that must be satisfied by a recipient of the transfer message in order for the transfer of the indicated amount to be completed successfully.

The first operand element 818 provides user selectable options to receive data indicating a first operand. As illustrated, the first operand element 818 offers selection of a first operand from a list of operands. The first operand may be, include or indicate a variable, data type, or placeholder. The placeholder may be a placeholder for a property of the recipient or recipient account. The list of operands may include, for example, a “recipient age”, “recipient name”, “recipient address”, “account age”, “account type” and “account value” operand. As illustrated, no first operand has been selected.

The comparison operator element 820 provides user selectable options to receive data indicating the comparison operation. In some embodiments, a comparison operator may be provided for selection as well as the possibility of specifying a different operator with additional input.

The comparison operator element 820 offers selection of an operator from a list of comparison operators. The list of comparison operators may include, for example, an “equal to”, “not equal to”, “greater than”, “less than”, “greater than or equal to”, “less than or equal to”, “contains” operator. As illustrated, the “is equal to” operator is pre-selected.

The comparison operator may be or include a “matches” operator to test whether a field is an exact match for a pattern. One operand may be a pattern and the other may be treated as a string value. The operator may return true if the pattern matches the string. If the pattern matches only part of the string or doesn’t match at all, the result of the match operator is false.

The second operand element 822 provides an input area to receive data indicating the second operand.

By way of example, the deposit or acceptance condition feature 816 may be used to indicate an acceptance condition whereby the first operand is “recipient name”, the operand is “matches”, and the second operand is “John Doe”, which may be evaluated by a second system to confirm that “John Doe” is the account holder of the account specified in the routing data.

The remote device transmits to the transferor system a payment instruction with respect to the payment. The instruction is received by the transferor system via the money transfer interface 800, through the selection of a confirmation element 824. The payment message may include the selection and configuration details of one or more options or features, including the transferor’s account, transfer amount, routing data, and acceptance condition.

The deposit condition may be included in the metadata of the payment message. It may be inserted by the transferor system. In some instances, it may be inserted based on an instruction received from a client device associated with the sender, namely the remote device. That is, the deposit condition may be a user-input condition.

In some instances, the money transfer interface 800 may not include a deposit or acceptance condition feature 816. The deposit condition may be automatically included when the payment is sent from a particular sender account. For example, a sender may require that all recipients of payments from its account be over the age of majority. Or, a sender may require that a deposit condition requiring a comparison of a name be included in all outgoing payments. Further, the inclusion of the deposit condition may be automatically done when the amount of the payment exceeds a threshold. For example, the name comparator may not be included if the payment is less than $20 but it may be included if the payment is greater than $20.

When the payment instruction is received by the transferor system, the transferor system may transmit a payment message including the payment details to the recipient system. The recipient system may then process the payment message according to the method 700 of FIG. 7. If the condition is satisfied, the indicated amount may be transferred from the transferor’s account to the account specified in the routing data.

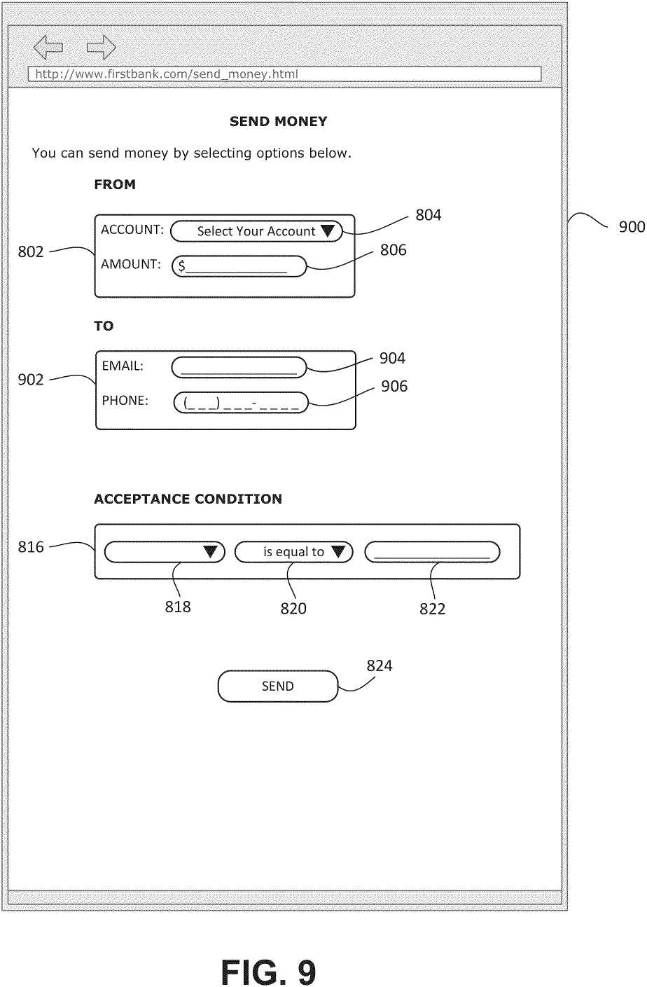

Reference will now be made to FIG. 9 which illustrates another example money transfer interface 900. The money transfer interface 900 may include one or more features 802, 816 and 824 and corresponding user interface elements as shown in FIG. 8.

The money transfer interface 900 may further include a recipient alias feature 902 for providing an input area to receive an alias of the recipient (e.g. email address or phone number). The recipient alias feature 902 includes an email element 904 and a phone number element 906 that provide input areas to data indicating an email address and phone number that each identify and are associated with the recipient.

When the transferor system receives the payment instruction from the remote device, the transferor system may use the recipient alias to lookup routing data associated with the recipient and send the payment message to the recipient system, or the transferor system may send the recipient alias in a payment message to a separate system that can replace the recipient alias with routing data in order to forward the payment message to the recipient system.

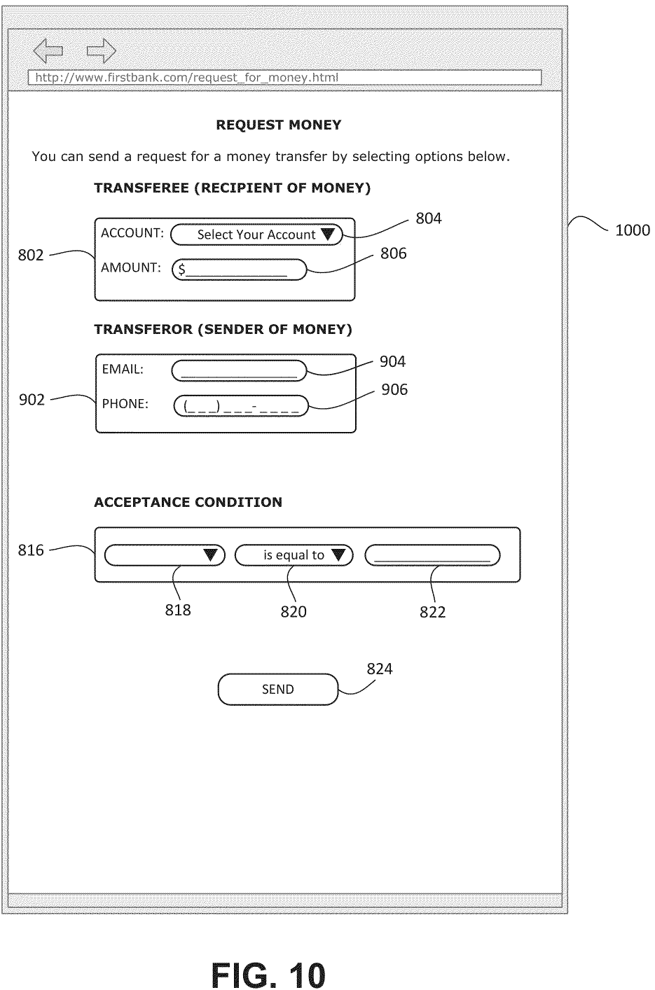

Reference will now be made to FIG. 10 which illustrates a money transfer interface 1000. The money transfer interface 1000 may include one or more features 802, 808, 816, 824 and 902 and corresponding user interface elements as shown in FIGS. 8 and 9.

Whereas FIGS. 8 and 9 are directed at payment interfaces, the money transfer interface 1000 shown in FIG. 10 is a request for payment interface. In particular, the role of the user of the remote device is reversed, as they are now the recipient rather than the sender of the payment. It will be appreciated that some or all of the features 802, 808, 816, 824 and 902 and corresponding user interface elements may be modified as a result.

The remote device transmits to the recipient system a request for payment instruction with respect to the request for payment. The instruction is received by the recipient system via the request for payment interface 1000, through the selection of a confirmation element 824. The request for payment message may include the selection and configuration details of one or more options or features, including the transferee’s account, transfer amount, routing data, and acceptance condition.

When the request for payment instruction is received by the recipient system, the recipient system may transmit a request for payment message including the request for payment details to the transferor system. The transferor system may then process the request for payment message according to the method 700 of FIG. 7. If the condition is satisfied, the indicated amount may be transferred from the transferor’s account to the recipient’s account. In this way, the deposit condition may be included in a request for payment rather than a payment message to ensure that the sender satisfies certain criteria. For example, a lottery company may send a request for payment to an individual purchasing a lottery ticket and the request for payment may include a condition that the sender be of the age of majority.

It will be further appreciated that it may be that some or all of the above-described operations of the various above-described example methods may be performed in orders other than those illustrated and/or may be performed concurrently without varying the overall operation of those methods.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A first computing system comprising:
a communications module;
a processor coupled to the communications module; and
a memory coupled to the processor storing instructions that, when executed by the first computer system, cause the first computer system to:
receive, from a second computing system, a transfer message for a transfer between a first account associated with the first computing system and a second account associated with the second computing system, the transfer message including routing data, an amount of resources to be transferred, and a condition associated with the transfer;
evaluate the condition associated with the transfer based on a comparison between data included in the transfer message and one or more parameters associated with the first account; and
when the condition is determined to be satisfied, complete the transfer.

2. The computer system of claim 1, wherein the comparison between data included in the transfer message and one or more parameters associated with the first account includes a comparison between a value specified by the condition and one or more parameters associated with the first account.

3. The computer system of claim 1, wherein the condition includes a value to be used in the comparison.

4. The computer system of claim 1, wherein the one or more parameters associated with the first account include an age of the first account or a type of the first account.

5. The computer system of claim 1, wherein the one or more parameters associated with the first account include contact information of an account holder.

6. The computer system of claim 1, wherein the one or more parameters associated with the first account include an age of an account holder.

7. The computer system of claim 1, wherein the transfer message is provided as a request for payment.

8. The computer system of claim 1, wherein the instructions further cause the first computer system to:
when the condition is determined to not be satisfied, stop the transfer from being completed.

9. The computer system of claim 1, wherein the instructions further cause the first computer system to:
send, in real time or near real time upon receipt of the transfer message, a reply to the second computing system indicating the result of the evaluation.

10. The computer system of claim 1, wherein receiving the transfer message indicating the condition associated with the transfer includes receiving user input from a client device via the second system indicating the condition associated with the transfer.

11. A method comprising:
receiving, from a second computing system, a transfer message for a transfer between a first account associated with a first computing system and a second account associated with the second computing system, the transfer message including routing data, an amount of resources to be transferred, and a condition associated with the transfer;
evaluating the condition associated with the data transfer based on a comparison between data included in the transfer message and one or more parameters associated with the first account; and
when the condition is determined to be satisfied, completing the transfer.

12. The method of claim 11, wherein the comparison between data included in the transfer message and one or more parameters associated with the first account includes a comparison between a value specified by the condition and one or more parameters associated with the first account.

13. The method of claim 11, wherein the condition includes a value to be used in the comparison.

14. The method of claim 11, wherein the one or more parameters associated with the first account include an age of the first account or a type of the first account.

15. The method of claim 11, wherein the one or more parameters associated with the first account include contact information of an account holder.

16. The method of claim 11, wherein the one or more parameters associated with the first account include an age of an account holder.

17. The method of claim 11, wherein the transfer message is provided as a request for payment.

18. The method of claim 11, further comprising:
when the condition is determined to not be satisfied, stopping the transfer from being completed.

19. The method of claim 11, further comprising:
sending, in real time or near real time upon receipt of the transfer message, a reply to the second computing system indicating the result of the evaluation.

20. A non-transitory computer-readable storage medium comprising processor-executable instructions which, when executed, configure a processor to:
receive, from a second computing system, a transfer message for a transfer between a first account associated with a first computing system and a second account associated with the second computing system, the transfer message including routing data, an amount of resources to be transferred, and a condition associated with the transfer;
evaluate the condition associated with the data transfer based on a comparison between data included in the transfer message and one or more parameters associated with the first account; and
when the condition is determined to be satisfied, complete the transfer.
